(19) United States
(12) Patent Application Publication
(10) Pub. No.: US 2017/0344995 A1
(43) Pub. Date: Nov. 30, 2017

(54) REMOTE TRANSACTION CONNECTION

(71) Applicant: NCR Corporation, Duluth, GA (US)

(72) Inventors: Matthew Phillip Kamp, Cumming, GA (US); Jonathan Wesley Lawrence, Cumming, GA (US); David Mayo, Cumming, GA (US); Bill Ward, Duluth, GA (US)

(21) Appl. No.: 15/168,727

(22) Filed: May 31, 2016

(51) Int. Cl. G06Q 20/40; G06Q 20/20; G06K 19/06; G06Q 20/32; G06K 7/10

(52) U.S. Cl. CPC G06Q 20/405; G06Q 20/3278; G06Q 20/3274; G06K 7/10722; G06K 19/06112; G06Q 20/20

(57) ABSTRACT

Various embodiments herein each include at least one of systems, methods, devices, and software for remote transaction connection, such as connecting a transaction entered at a Point-Of-Sale (POS) terminal to a payment session on a mobile device to enable payment for the transaction conducted on the POS terminal via the mobile device. One such embodiment includes presenting a scanable code via an output device, the scanable code associated in a transaction processing system with an open transaction for which additional input is requested by the presenting of the scanable code. This method further includes receiving data from the transaction processing system indicating the requested additional input has been received and provisioning of at least one item associated with the open transaction is authorized and closing the transaction.

### BACKGROUND INFORMATION

Mobile payments, such as via mobile wallet apps, that can be made via smartphones and other mobile devices are becoming common. Making mobile payments is generally easy to do and some solutions offer a relatively high degree of security. However, mobile payments are not very easy to make at drive-thru outlets, such as restaurants and coffees shops. Making a mobile payment typically requires the payor to place a mobile device (e.g., smartphone, smartwatch, tablet, etc.) in proximity to a wired sensor. The sensor at a drive-thru may need to be passed or held out to the customer. The sensor device and the payor's mobile device are subject to risk of excess wear, dropping, and exposure to rain. Thus, while mobile payments are becoming common, mobile payments at drive-thru outlets are cumbersome, risk damage to devices, and are simply not as easy as in other contexts.

### SUMMARY

Various embodiments herein each include at least one of systems, methods, devices, and software for remote transaction connection, such as connecting a transaction entered at a Point-Of-Sale (POS) terminal to a payment session on a mobile device to enable payment for the transaction conducted on the POS terminal via the mobile device.

One such embodiment includes presenting a scanable code via an output device, the scanable code associated in a transaction processing system with an open transaction for which additional input is requested by the presenting of the scanable code. This method further includes receiving data from the transaction processing system indicating the requested additional input has been received and provisioning of at least one item associated with the open transaction is authorized and closing the transaction.

Another method embodiment includes receiving data representative of an open transaction and a transaction identifier. This method embodiments further includes receiving, via a network from an app that executes on a mobile device, data including the transaction identifier and additional data with regard to the open transaction. The additional data is then processed and the method transmits, via the network to a point-of-sale terminal on which the transaction was opened, data indicating the data received from the mobile device has been successfully processed and that the open transaction can be completed.

A further embodiment, in the form of an output terminal, includes an output device, such as a display device, a printer, a radio transceiver device, and the like. The output terminal further includes a controller coupled to the output device including at least one interface device to receive data, at least one processor, and at least one memory device storing instructions executable on the at least one processor to perform data processing activities. The data processing activities include receiving a data set to output via the output device and outputting the dataset via the output device, the dataset associated in a transaction processing system with an open transaction for which additional input is requested by the outputting of the dataset.

### BRIEF DESCRIPTION OF THE DRAWINGS

FIG. 1 is a logical block diagram of a system, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, methods, devices, and software for remote transaction connection, such as connecting a transaction entered at a Point-Of-Sale (POS) terminal to a payment session on a mobile device to enable payment for the transaction conducted on the POS terminal via the mobile device. For example, a transaction may be initiated at a POS terminal within a restaurant for drive-thru window. The order is taken via an intercom system from a customer in a car and restaurant personnel enter the order within the POS terminal. The drive-thru terminal where the customer places the order may include an output device, such as a display device or a Near Field Communication (NFC) radio transceiver device. Once the order has been entered within the POS terminal, the POS terminal may transmit a transaction code in the form of one or more of a barcode image or dataset to be presented in a barcode to be generated, an NFC signal to be transmitted, and the like depending upon the type of output device.

The drive-thru customer then utilizes a mobile device to receive the transaction code, such as via a camera within an app capable of reading a barcode or to act upon a received NFC signal. The transaction code then informs the receiving app or provides data that will lead the mobile to an interface within which a payment for the drive-thru order may be provided. The payment information may be provided via a mobile payment solution in some embodiments, while in other embodiments, payment information may be input, a link to an electronic wallet solution (e.g., PAYPAL) may be provided, and the like. Once the payment information is provided, the payment is transmitted to a transaction processing system 116 of the drive-thru establishment and upon successfully processing the payment, a payment received signal is transmitted to the POS terminal. Items of the order may then be provided to the customer. Such solutions enable drive-thru customers to pay via mobile payment solutions but avoid the cumbersome reality of current mobile payments at drive-thru outlets.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural logical and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

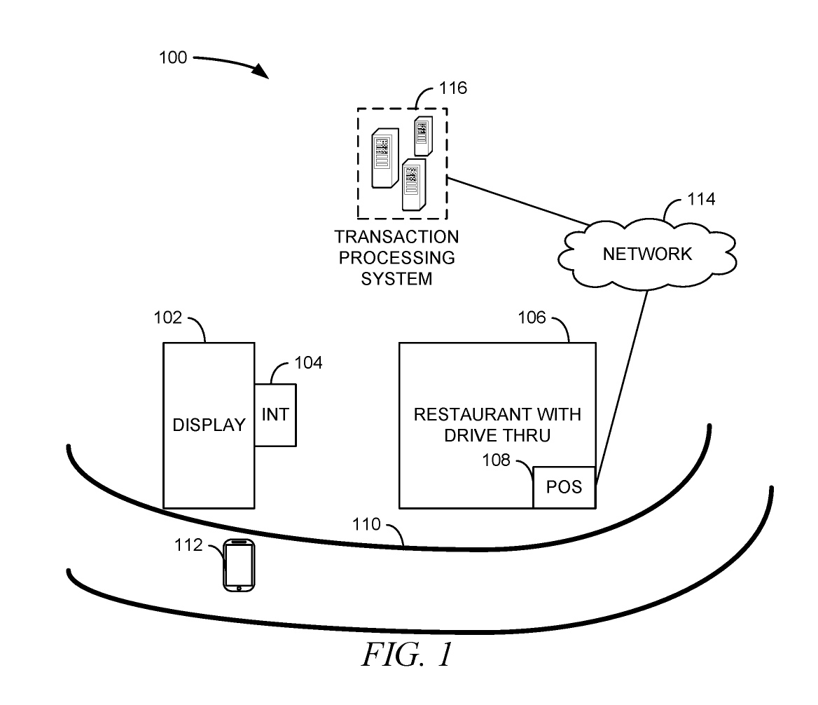

FIG. 1 is a logical block diagram of a system 100, according to an example embodiment. The system 100 is deployed in a drive-thru context, such as a drive-thru at a quick serve restaurant 106. The restaurant 106 includes a POS terminal 108 utilized by personnel to enter drive-thru orders received via an intercom 104 from customers present in a drive-thru lane 110. Located proximate to the intercom 104 at the drive-thru order location is a display 102. The display 102 may present a view of one or more of a menu, a listing of ordered items, and amount due for the order, and a barcode. A barcode presented on the display 102 is generally received from the POS 108 terminal and is unique to a transaction for a customer's drive-thru order. The barcode can be scanned by a mobile device 112 of the customer to make a payment for the current order. Note that in some embodiments, rather than a display 102, another output device may provided the code to enable payment for the order on the mobile device 112, such as an NFC transceiver device or other output device.

Regardless of how the customer mobile device receives the code, the code instructs the mobile device 112 or an app that executes thereon, to connect to a payment solution to provide payment data to a transaction processing system. The code may also link the mobile device 112 or the app that executes thereon to a detailed listing of items ordered. Regardless, a payment interface is presented on the mobile device 112 to offer the user one or more ways to provide payment for the order. Such options may be to use a mobile payment solution present on the mobile device 112, a mobile wallet solution (e.g., PAYPAL), to input bankcard information, and the like. Once the payment information is input, the data is transmitted from the mobile device 112 to the transaction processing system 116. When the transaction processing system 116 has successfully processed the payment, a signal is sent via a network 114 to the POS terminal 108 indicating payment has been received and the ordered items may be provided to the customer.

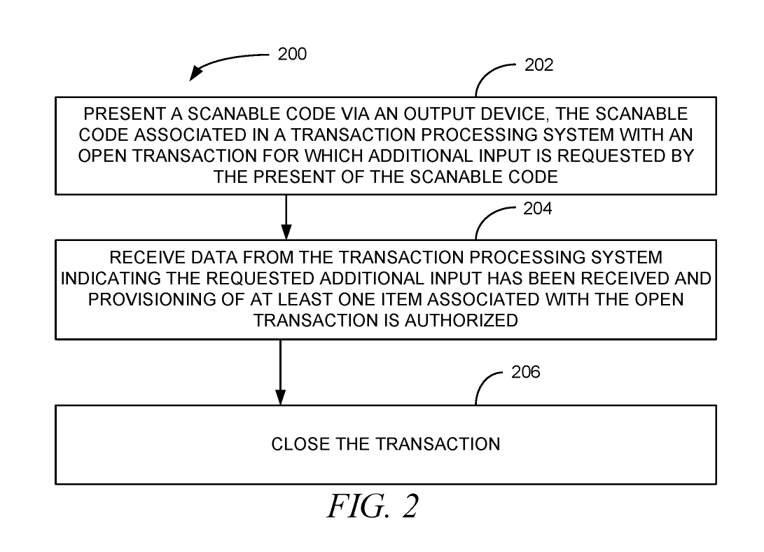

FIG. 2 is a block flow diagram of a method 200, according to an example embodiment. The method 200 is an example of a method that may be performed by a POS terminal in some embodiments. The method 200 includes presenting 202 a scanable code via an output device. The presented 202 scanable code is associated in a transaction processing system with an open transaction for which additional input is requested by the presenting of the scanable code. The method 200 further includes receiving 204 data from the transaction processing system indicating the requested additional input has been received and provisioning of at least one item associated with the open transaction is authorized. The method 200 further includes closing 206 the transaction.

In some embodiments of the method 200, the transaction processing system is a payment transaction processing system and the additional input includes payment input in an amount of the open transaction. The scanable code, in some embodiments, is a barcode that is scanable by an imaging device of a mobile device. The barcode of such embodiments may be encoded with data to instruct an app that executes on the mobile device to request the additional input, which when received within the app on the mobile device, will be transmitted by the app from the mobile device over a network to the transaction processing system to enable the closing of the transaction. In some such embodiments, presenting 202 the scanable code includes presenting the barcode at least once on a display device present at a location where initial input is received with regard to the transaction. However, the barcode may be presented 202 in multiple locations at various heights to enable a customer to scan the barcode at a height that is easy to reach depending on the height of the customer's vehicle. However, in some embodiments, the barcode may be presented 202 in only a single location but the display device moved to a height that is well suited to the customer's vehicle height.

In some embodiments, the initial input, as mentioned in the preceding paragraph, is order input received at a drive-thru outlet ordering location where the display device on which the barcode is presented is also located. The barcode in some such embodiments is presented 202 either simultaneously or sequentially at each of a plurality of heights on the display device.

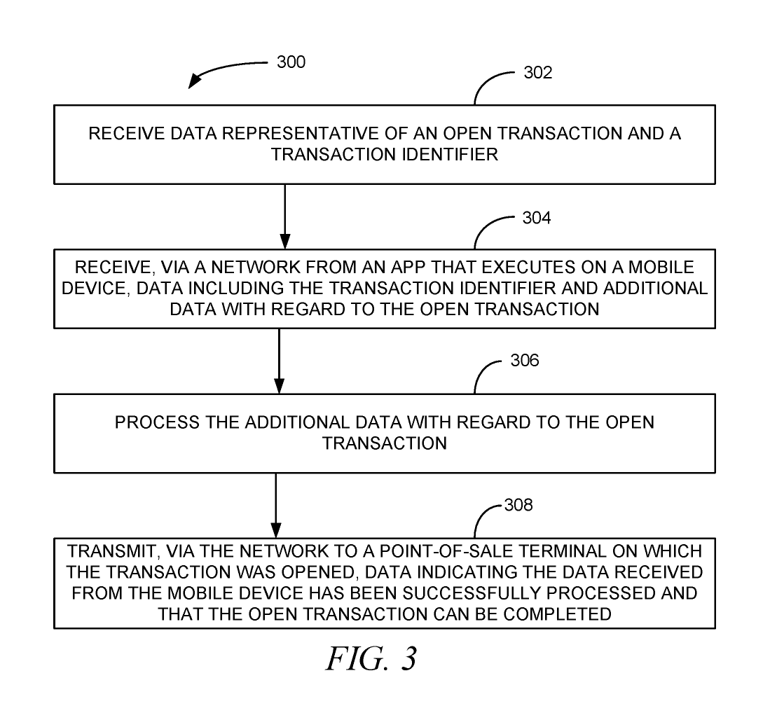

FIG. 3 is a block flow diagram of a method 300, according to an example embodiment. The method 300 is an example of a method that may be performed by a transaction processing system, such as transaction processing system 116 of FIG. 1. The method 300 includes receiving 302 data representative of an open transaction and a transaction identifier and receiving 304, via a network from an app that executes on a mobile device, data including the transaction identifier and additional data with regard to the open transaction. The method 300 may then process 306 the additional data with regard to the open transaction and transmit 308, via the network to a point-of-sale terminal on which the transaction was opened, data indicating the data received from the mobile device has been successfully processed and that the open transaction can be completed. In some such embodiments, the open transaction is a restaurant order and the data representative of the open transaction includes an amount payable.

In some embodiments of the method 300, the data received 304 from the app that executes on the mobile device includes bankcard data to which the amount payment is to be charged and the processing 306 of the additional data with regard to the open transaction includes processing a payment for the amount payable based on the bankcard data. In a further embodiment, the data indicating the data received from the mobile device has been successfully processed indicates the payment was successfully processed the data indicating the open transaction can be completed indicates food of the restaurant order has been paid for.

In some additional embodiments, the data representative of the open transaction and the transaction identifier are received 302 with the data including the transaction identifier and the additional data with regard to the open transaction, the data representative of the open transaction identifying the point-of-sale terminal on which the transaction was opened.

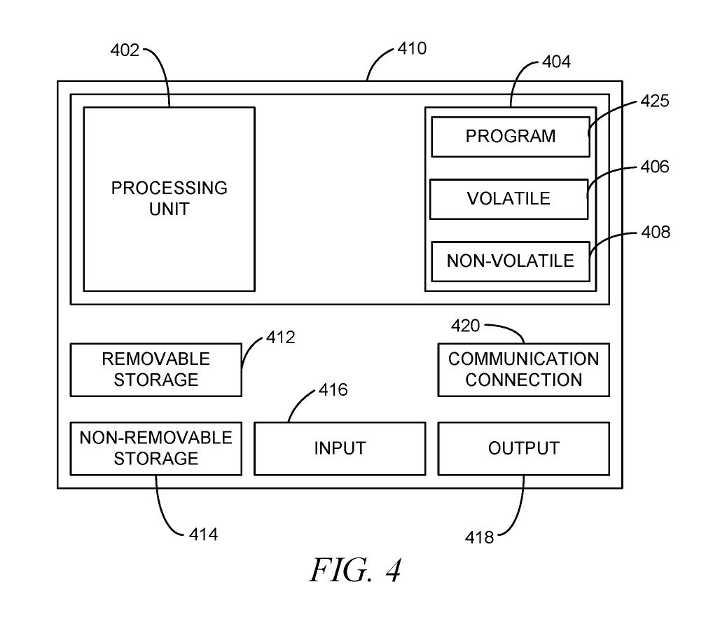

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
presenting a scanable code via an output device, the scanable code associated in a transaction processing system with an open transaction for which additional input is requested by the presenting of the scanable code;
receiving data from the transaction processing system indicating the requested additional input has been received and provisioning of at least one item associated with the open transaction is authorized; and
closing the transaction.

2. The method of claim 1, wherein the transaction processing system is a payment transaction processing system and the additional input includes payment input in an amount of the open transaction.

3. The method of claim 1, wherein the scanable code is a barcode that is scanable by an imaging device of a mobile device, the barcode encoded with data to instruct an app that executes on the mobile device to request the additional input, which when received within the app on the mobile device, will be transmitted by the app from the mobile device over a network to the transaction processing system to enable the closing of the transaction.

4. The method of claim 3, wherein presenting the scanable code includes presenting the barcode at least once on a display device present at a location where initial input is received with regard to the transaction.

5. The method of claim 4, wherein the initial input is order input received at a drive-thru outlet ordering location where the display device on which the barcode is presented is also located.

6. The method of claim 5, wherein the barcode is presented either simultaneously or sequentially at each of a plurality of heights on the display device.

7. The method of claim 5, wherein the drive-thru outlet is a restaurant.

8. The method of claim 1, wherein the output device is a radio-transceiver device that is receivable by a radio-transceiver device of a mobile device on which the addition input can be received.

9. A method comprising:
receiving data representative of an open transaction and a transaction identifier;
receiving, via a network from an app that executes on a mobile device, data including the transaction identifier and additional data with regard to the open transaction;
processing the additional data with regard to the open transaction;
transmitting, via the network to a point-of-sale terminal on which the transaction was opened, data indicating the data received from the mobile device has been successfully processed and that the open transaction can be completed.

10. The method of claim 9, wherein the open transaction is a restaurant order and the data representative of the open transaction includes an amount payable.

11. The method of claim 9, wherein:
the data received from the app that executes on the mobile device includes bankcard data to which the amount payment is to be charged; and
the processing of the additional data with regard to the open transaction includes processing a payment for the amount payable based on the bankcard data.

12. The method of claim 11, wherein:
the data indicating the data received from the mobile device has been successfully processed indicates the payment was successfully processed; and
the data indicating the open transaction can be completed indicates food of the restaurant order has been paid for.

13. The method of claim 9, wherein the data representative of the open transaction and the transaction identifier are received with the data including the transaction identifier and the additional data with regard to the open transaction, the data representative of the open transaction identifying the point-of-sale terminal on which the transaction was opened.

14. The method of claim 9, wherein the data representative of the open transaction and the transaction identifier are received via the network from the point-of-sale terminal.

15. An output terminal comprising:
an output device; and
a controller coupled to the output device including at least one interface device to receive data, at least one processor, and at least one memory device storing instructions executable on the at least one processor to perform data processing activities comprising:
receiving a data set to output via the output device; and
outputting the dataset via the output device, the dataset associated in a transaction processing system with an open transaction for which additional input is requested by the outputting of the dataset.

16. The output terminal of claim 15, wherein the output device is a display device, the dataset is a barcode encoded with the data of the dataset, and the outputting of the dataset includes displaying the barcode on the display device.

17. The output terminal of claim 16, wherein displaying the barcode on the display device includes displaying the barcode either simultaneously or sequentially at each of a plurality of height locations on the display device.

18. The output terminal of claim 15, wherein the output device is a radio transceiver device that outputs the dataset therefrom.

19. The output terminal of claim 18, wherein the radio transceiver device is a Near-Field Communication (NFC) device.
